(19) United States
(12) Patent Application Publication
(10) Pub. No.: US 2006/0182903 A1
(43) Pub. Date: Aug. 17, 2006

(54) Ink-jet recording material

(75) Inventors: Hiroshi Sakaguchi, TOKYO (JP); Kazuhiko Sunada, Tokyo (JP); Hideto Kiyama, Tokyo (JP); Hideaki Ishiguro, Tokyo (JP); Shuzo Kinoshita, Tokyo (JP)

Correspondence Address: BIRCH STEWART KOLASCH & BIRCH, PO BOX 747, FALLS CHURCH, VA, 22040-0747, US

(73) Assignee: MITSUBISHI PAPER MILLS LIMITED, TOKYO (JP)

(21) Appl. No.: 10/536,383

(22) PCT Filed: Nov. 27, 2003
(86) PCT No.: PCT/JP03/15142

§ 371 Date: Feb. 28, 2006

(30) Foreign Application Priority Data
Nov. 27, 2002 (JP) 2002-343238
Feb. 24, 2003 (JP) 2003-045753

(51) Int. Cl. B41M 5/00

(52) U.S. Cl. 428/32.24

(57) ABSTRACT

The present invention discloses an ink-jet recording material having a support and at least two ink-receptive layers containing inorganic fine particles and a hydrophilic binder, which comprises an ink-receptive layer A nearer to the support containing precipitated silica fine particles having an average secondary particle diameter 500 nm or less, or precipitated silica fine particles having an average secondary particle diameter 500 nm or less and fumed silica fine particles having an average secondary particle diameter 500 nm or less, and containing less than 20 parts by weight of a polyvinyl alcohol based on 100 parts by weight of the whole silica fine particles in the ink-receptive layer A, and an ink-receptive layer B farther from the support containing at least one kind of fine particles selected from fumed silica, alumina and alumina hydrate and less than 25 parts by weight of a polyvinyl alcohol based on 100 parts by weight of the fine particles.

### TECHNICAL FIELD

The present invention relates to an ink-jet recording material for recording in an ink-jet recording system such as an ink-jet printer, etc., more specifically to an ink-jet recording material having high glossiness, excellent in color forming property, less color blur that generates during preservation after printing with a dye ink, excellent in ink-absorption property and resistance to crack by folding, and further excellent in flaw resistance, and less surface defects caused by accompanying with multi-layer coating.

### BACKGROUND ART

As the recording material to be used for an ink-jet recording system, a usual paper or a recording material in which a porous ink-receptive layer comprising a pigment such as amorphous silica, etc., and a hydrophilic binder such as a polyvinyl alcohol, etc. is provided on a support that is so-called ink-jet recording paper has been known.

For example, a recording material obtained by coating a silicon-containing pigment such as silica, etc. with a hydrophilic binder on a paper support has been used. Also, there has been disclosed to use silica fine particles in which precipitated silica agglomerate had been pulverized to 10 to 300 nm by a mechanical means (for example, see Japanese Unexamined Patent Publications No. Hei. 9-286165, No. Hei. 10-181190). However, these recording materials are not yet sufficiently satisfied in a surface glossiness and coloring property to be obtained for a photo-like recording material which is an object of the present invention.

On the other hand, it has been proposed a recording material in which the ink-receptive layer is made a two-layer structure, and the upper layer is made a layer having a relatively higher glossiness. For example, it has been known a recording material in which a layer containing colloidal silica, alumina or alumina hydrate is provided as a gloss providing layer on an ink-receptive layer mainly comprising an inorganic pigment, etc. (see, for example, Japanese Unexamined Patent Publications No. 2000-37944 and No. Hei.7-89216). Also, it has been proposed a recording material in which pulverized amorphous synthetic silica is contained in a lower layer, and a layer containing fumed silica is provided at an upper layer (see, for example, Japanese Unexamined Patent Publication No. 2001-80204), or a recording material in which pulverized gel method silica is contained in a lower layer, and an upper layer containing fumed silica or alumina is provided (see, for example, Japanese Unexamined Patent Publication No. 2001-277712), and further, there is disclosed a recording material in which a lower layer containing fumed silica and an upper layer containing alumina or alumina hydrate are provided (see, for example, WO 02/34541 A1).

On the other hand, accompanying with high quality in image of an ink-jet printer, printing which is equal to a silver salt photograph can be realized. For example, to realize a photo-like image, a recording system with higher image quality has been proposed in an ink-jet printer side, by using a light color ink which is so-called photo ink, or an intermediate color ink such as gray, dark yellow, etc., and commercially available.

As a recording material for photography, it has not yet been satisfied by the above-mentioned recording material, and further improvement in glossiness and coloring property has been desired. Also, when printing is carried out by using dye ink, a recording material prevented from color blur caused during preservation has been desired. Also, more improved ink absorption property has been desired. It is an effective means to realize higher ink absorption property that an ink-receptive layer is thickened, but it involves the problem that crack (crack by folding) occurs at an ink-receptive layer even when slightly bending the recording material at the time of handling the same. This is because the recording material has a constitution in which an ink-receptive layer is inherently high brittleness to ensure high ink absorption property to the recording material, and yet the coating layer with high brittleness is made thick.

As a means to prevent from causing the above-mentioned crack by folding, it is effective to make little a ratio of an inorganic pigment/a binder in the ink-receptive layer or reduce an amount of boric acid or a borate to be added which is added as a cross-linking agent of the binder. However, according to the means to make an inorganic pigment/binder ratio little, an ink absorption property becomes worse. Also, according to the means to decrease an amount of boric acid or a borate to be added, worsening in an ink absorption property occurs, and further, glossiness sometimes lowers or uneven glossiness sometimes occurs.

Moreover, there is a problem in these two-layer constitution recording materials that coating defects such as cracking, etc. increase in the preparation process. Whereas it is uncertain about the mechanism of causing the coating defects, it is estimated to be caused by subjecting to multi-layer coating two layers with different shrinkage rates at drying. Japanese Unexamined Patent Publication No. 2003-211824 discloses a technique of using precipitated silica and fumed silica in combination. However, that disclosed therein is to provide an ink-jet recording material with a low cost by making a coating solution high concentration, and there is neither suggested nor disclosed to avoid disorder accompanied by multi-layer coating.

An object of the present invention is to provide an ink-jet recording material having high glossiness and excellent in color forming property, and causes less color blur which occurs during preservation after printing with dye ink. The second object is to provide an ink-jet recording material which is excellent in ink absorption property, coloring property, and resistance to crack by folding, and further excellent in glossiness and flaw resistance. The third object is to provide an ink-jet recording material which causes a little surface defect which occurs accompanying with multi-layer coating.

### DISCLOSURE OF THE INVENTION

The above-mentioned objects of the present invention can be accomplished by the following ink-jet recording material.

1. An ink-jet recording material having a support and at least two ink-receptive layers containing inorganic fine particles and a hydrophilic binder, which comprises an ink-receptive layer A nearer to the support containing precipitated silica fine particles having an average secondary particle diameter 500 nm or less, or precipitated silica fine particles having an average secondary particle diameter 500 nm or less and fumed silica fine particles having an average secondary particle diameter 500 nm or less, and containing less than 20 parts by weight of a polyvinyl alcohol based on 100 parts by weight of the whole silica fine particles in the ink-receptive layer A, and an ink-receptive layer B farther from the support containing at least one kind of fine particles selected from fumed silica, alumina and alumina hydrate and less than 25 parts by weight of a polyvinyl alcohol based on 100 parts by weight of the fine particles.

2. The ink-jet recording material according to the above-mentioned 1, wherein the precipitated silica fine particles having an average secondary particle diameter of 500 nm or less are fine particles in which precipitated silica is pulverized to have an average secondary particle diameter of 500 nm or less in an aqueous medium.

3. The ink-jet recording material according to the above-mentioned 2, wherein the fine particles in which the precipitated silica is pulverized are fine particles in which precipitated silica having an average secondary particle diameter of 5 μm or more is pulverized by using media mill in the presence of a cationic compound in an aqueous medium.

4. The ink-jet recording material according to the above-mentioned 3, wherein an oil absorption amount of the precipitated silica is 210 ml/100 g or less.

5. The ink-jet recording material according to the above-mentioned 1, wherein the fumed silica fine particles having an average secondary particle diameter of 500 nm or less are fine particles in which fumed silica is pulverized to have an average secondary particle diameter of 500 nm or less in the presence of a cationic compound in an aqueous medium.

6. The ink-jet recording material according to the above-mentioned 1, wherein a weight ratio of the precipitated silica fine particles and fumed silica fine particles contained in the ink-receptive layer A is 30:70 to 70:30.

7. The ink-jet recording material according to the above-mentioned 1, wherein the ink-receptive layer A contains boric acid or a borate.

8. The ink-jet recording material according to the above-mentioned 1, wherein a dry coated amount of the ink-receptive layer B containing the fumed silica is 4 g/m² or less in an amount of the fumed silica.

9. The ink-jet recording material according to the above-mentioned 1, wherein the ink-receptive layer B contains boric acid or a borate.

10. The ink-jet recording material according to the above-mentioned 1, wherein the alumina hydrate is a plate shaped alumina hydrate having an aspect ratio of 2 or more.

11. The ink-jet recording material according to the above-mentioned 1, wherein the alumina hydrate is pseudoboehmite.

12. The ink-jet recording material according to the above-mentioned 1, wherein the alumina is γ-alumina.

13. The ink-jet recording material according to the above-mentioned 1, wherein a layer mainly comprising colloidal silica is further provided on the ink-receptive layer B.

14. The ink-jet recording material according to the above-mentioned 1, wherein the support is a water-resistant support.

### BEST MODE FOR CARRYING OUT THE INVENTION

In the following, the present invention is explained in detail.

As the support to be used in the present invention, there may be used a film such as a polyethylene, polypropylene, polyvinyl chloride, diacetate resin, triacetate resin, cellophane, acrylic resin, polyethyleneterephthalate, polyethylenenaphthalate, etc., a water-resistant support such as a resin-coated paper, etc., and a water-absorptive support such as uncoated paper, art paper, coated paper, cast-coated paper, etc. Preferably used is a water-resistant support. In particular, a thickness of these supports having about 50 to 250 μm or so is preferably used.

Silica fine particles to be used in the present invention is amorphous synthetic silica, and the amorphous synthetic silica can be roughly classified into fumed silica, wet process silica, and others according to the preparation method. Fumed silica is also called to as the dry process silica, and it can be generally prepared by a flame hydrolysis method. More specifically, it has generally been known a method in which silicon tetrachloride is burned with hydrogen and oxygen, and the fumed silica is commercially available from Nippon Aerosil K. K. (Japan) under the trade name of Aerosil, and K. K. Tokuyama (Japan) under the trade name of QS type, etc.

The wet process silica can be further classified into a precipitation method silica, a gel method silica and a sol method silica according to the preparation processes. The precipitation method silica can be prepared by reacting sodium silicate and sulfuric acid under alkali conditions, silica particles grown in particle size aggregated and precipitated, and then, they are processed through filtration, washing, drying, pulverization and classification to prepare a product. The silica secondary particles prepared by the method form softly agglomerated particles and particles that can be relatively easily pulverized can be obtained. As the precipitation method silica, it is commercially available from NIPPON SILICA CORPORATION as Nipsil, and K. K. Tokuyama as Tokusil or Finesil. The gel method silica can be produced by reacting sodium silicate and sulfuric acid under acidic conditions. In this method, small silica particles are dissolved during ripening and so reprecipitated between other primary particles which are larger sized particles that primary particles are combined to each other. Thus, clear primary particles disappear and form relatively hard agglomerated particles having inner void structure. For example, it is commercially available from Mizusawa Industrial Chemicals, Ltd. as Mizukasil, or Grace Japan Co., Ltd. as Sylojet. The sol method silica is also called to as colloidal silica and can be obtained by heating and ripening silica sol obtained by methathesis of sodium silicate by an acid, etc., or passing through an ion-exchange resin layer, and is commercially available from, for example, Nissan Chemical Industries, Ltd. as SNOWTEX.

In the ink-receptive layer A of the present invention, precipitated silica having an average secondary particle diameter of 500 nm or less is contained. The precipitated silica produced by the conventional method has an average secondary particle diameter of 1 μm or more, so that those of the silica pulverized to have 500 nm or less are used. As a pulverizing method, a wet type dispersing method in which silica dispersed in an aqueous medium is mechanically pulverized can be preferably used. As the wet type dispersing machine, a media mill such as a ball mill, a beads mill, a sand grinder, etc., a pressure type dispersing device such as a high-pressure homogenizer, an ultra high-pressure homogenizer, etc., an ultrasonic wave dispersing device, and a thin-film spin type dispersing device, etc., may be used, and in the present invention, use of a media mill such as a ball mill is particularly preferred.

The precipitated silica to be used in the ink-receptive layer A of the present invention preferably has an average primary particle diameter of 50 nm or less, particularly preferably 3 to 40 nm. Also, an oil absorption amount of the precipitated silica according to the present invention is preferably in the range of 120 to 210 ml/100 g, and the range of 160 to 210 ml/100 g is particularly preferred. The oil absorption amount can be measured based on the description of JIS K-5101.

Pulverization of the precipitated silica in the present invention is preferably carried out in the presence of a cationic compound. When the cationic compound is added to silica dispersed in water, agglomerated products frequently occur, but by subjecting the resulting material to pulverization treatment, dispersion with a higher concentration can be realized than they are dispersed only in water, and as a result, dispersion efficiency is increased so that they can be pulverized to finer particles. Moreover, by using a high concentration dispersion, it is possible to make a coating solution a higher concentration at the time of preparing the coating solution, and thus, there are merits that a production efficiency is improved. In particular, if the precipitated silica having an average secondary particle diameter of 5 μm or more is used at this time, increase in viscosity due to occurrence of agglomerated material at the initial stage can be prevented and dispersion with a higher concentration can be realized so that it is more advantageous. An upper limit of the average secondary particle diameter is not specifically limited, and the average secondary particle diameter of the precipitated silica is generally 200 μm or less.

As the cationic compound, a cationic polymer or a water-soluble metallic compound can be used. As the cationic polymer, polyethyleneimine, polydiallylamine, polyallylamine, polyalkylamine, as well as polymers having a primary to tertiary amino group or a quaternary ammonium group as disclosed in Japanese Unexamined Patent Publications No. Sho. 59-20696, No. Sho. 59-33176, No. Sho. 59-33177, No. Sho. 59-155088, No. Sho. 60-11389, No. Sho. 60-49990, No. Sho. 60-83882, No. Sho. 60-109894, No. Sho. 62-198493, No. Sho. 63-49478, No. Sho. 63-115780, No. Sho. 63-280681, No. Hei. 1-40371, No. Hei. 6-234268, No. Hei. 7-125411 and No. Hei. 10-193776, etc. Incidentally, these polymers may be a salt such as ammonium chloride, etc., when they are possible. In particular, a diallylamine derivative is preferably used as the cationic polymer. An average molecular weight of these cationic polymers is preferably 2,000 to 100,000 or so, particularly preferably 2,000 to 30,000 or so. If the molecular weight is larger than 100,000, the dispersion has higher viscosity so that it is not preferred.

As the water-soluble metallic compound, there may be mentioned, for example, a water-soluble polyvalent metal salt. There may be mentioned a water-soluble salt of a metal selected from calcium, barium, manganese, copper, cobalt, nickel, aluminum, iron, zinc, titanium, zirconium, chromium, magnesium, tungsten, and molybdenum. More specifically, there may be mentioned, for example, calcium acetate, calcium chloride, calcium formate, calcium sulfate, barium acetate, barium sulfate, barium phosphate, manganese chloride, manganese acetate, manganese formate dihydrate, manganese ammonium sulfate hexahydrate, cupric chloride, copper (II) ammonium chloride dihydrate, copper sulfate, cobalt chloride, cobalt thiocyanate, cobalt sulfate, nickel sulfate hexahydrate, nickel chloride hexahydrate, nickel acetate tetrahydrate, nickel ammonium sulfate hexahydrate, nickel amidesulfate tetrahydrate, aluminum sulfate, aluminum sulfite, aluminum thiosulfate, polyaluminum chloride, aluminum nitrate nonahydrate, aluminum chloride hexahydrate, ferrous bromide, ferrous chloride, ferric chloride, ferrous sulfate, ferric sulfate, zinc bromide, zinc chloride, zinc nitrate hexahydrate, zinc sulfate, zinc p-phenolsulfbnate, titanium chloride, titanium sulfate, titanium lactate, zirconium acetate, zirconium chloride, zirconium oxychloride octahydrate, zirconium hydroxy-chloride, chromium acetate, chromium sulfate, magnesium sulfate, magnesium chloride hexahydrate, magnesium citrate nonahydrate, sodium phosphotungstate, tungsten sodium citrate, dodecawolframatophosphate n hydrate, dodecawolframatosilicate 26 hydrate, molybdenum chloride, dodecamolybdatephosphate n hydrate, etc.

Of the above-mentioned water-soluble polyvalent metallic compounds, a compound comprising aluminum or a metal belonging to Group 4a (for example, zirconium, titanium) of the Periodic Table is preferred. Particularly preferred is a water-soluble aluminum compound. As the water-soluble aluminum compound, it has been known as an inorganic salt, for example, aluminum chloride or a hydrate thereof, aluminum sulfate or a hydrate thereof, aluminum alum, etc. Moreover, it has been known a basic poly(aluminum hydroxide) compound which is an inorganic aluminum-containing cationic polymer, and it is preferably used.

A main component of the above-mentioned basic poly(aluminum hydroxide) compound is shown by the following formula 1, 2 or 3, and is a water-soluble poly(aluminum hydroxide) containing a polynuclear condensed ion which is basic and a polymer in a stable form, such as [Al₆(OH)₁₅]³⁺, [Al₈(OH)₂₀]⁴⁺, [Al₁₃(OH)₃₄]⁵⁺, [Al₂₁(OH)₆₀]³⁺, etc.
[Al₂ (OH)ₙCl₆₋ₙ]ₘ Formula 1
[Al(OH)₃]ₙAlCl₃ Formula 2
Alₙ(OH)ₘCl₍₃ₙ₋ₘ₎0<m<3n Formula 3

These compounds are commercially available from Taki Chemical, K. K. under the name of poly(aluminum chloride) (PAC) as a water treatment agent, from Asada Chemical K. K. under the name of poly(aluminum hydroxide) (Paho), and from K. K. Riken Green under the name of Pyurakemu W T, and from other manufacturers with the same objects, whereby various kinds of different grades can be easily obtained.

As the water-soluble compound containing an element belonging to Group 4a of the Periodic Table to be used in the present invention, a water-soluble compound containing titanium or zirconium is more preferred. As the watersoluble compound containing titanium, there may be mentioned titanium chloride and titanium sulfate. As the water-soluble compound containing zirconium, there may be mentioned zirconium acetate, zirconium chloride, zirconium oxychloride, zirconium hydroxychloride, zirconium nitrate, basic zirconium carbonate, zirconium hydroxide, zirconium lactate, zirconium-ammonium carbonate, zirconium-potassium carbonate, zirconium sulfate, zirconium fluoride compound, etc. In the present invention, the term “water-soluble” means that a compound is soluble in water at normal temperature and normal pressure in an amount of 1% by weight or more.

A concrete method to obtain precipitated silica fine particles having an average secondary particle diameter of 500 nm or less according to the present invention comprises firstly adding at least one of silica and a cationic polymer and/or a cationic metallic compound into water and dispersing them by using at least one dispersing device such as a saw blade type dispersing device, a propeller blade type dispersing device, or a rotor stator type dispersing device and the like to obtain a provisional dispersion. Here, as a method of addition, it is preferred to add the precipitated silica particles as powder into water in which the cationic compound had previously been contained. If necessary, a suitably amount of a solvent with a low boiling point, etc. may be further added. An amount of the cationic polymer or the water-soluble metallic compound is preferably 0.5 to 20 parts by weight, more preferably 2 to 10 parts by weight based on 100 parts by weight of the silica. By making the above range, a viscosity of the silica provisional dispersion is not too high, and a concentration of the solid content can be made high. The concentration of the solid content of the silica provisional dispersion according to the present invention is preferably higher, but it is too high concentration, dispersion cannot be carried out, so that the preferred range is 20 to 60% by weight, more preferably 30 to 50% by weight.

The silica provisional dispersion obtained by the above-mentioned method is subjected to pulverization treatment with a bead mill. The bead mill means a device in which beads are filled in an apparatus having a stirring device therein, a liquid material is charged in the apparatus and the stirring device is rotated to collide beads with each other whereby a shearing force is applied to the liquid material to pulverize the same. A particle size of the beads is generally 0.1 to 10 mm, preferably 0.2 to 1 mm, more preferably 0.3 to 0.6 mm. As the beads, there are glass beads, ceramics beads, metal beads, etc., and zirconia beads are preferred in the points of abrasion resistance and dispersion efficiency. Also, a filling ratio of the beads to be added into an apparatus is generally 40 to 80% by volume, preferably 55 to 80% by volume. According to the above-mentioned dispersing conditions, a silica dispersion can be pulverized to particles having an average secondary particle diameter of 500 nm or less with good efficiency, without remaining coarse grains or generating agglomerated material. When the provisional dispersion is treated continuously and when coarse grains likely remain with a number of passing time being one, it is preferably treated twice or more. In the present invention, it is preferred that a concentration is high in the range in which coarse grains are not generated, since a coating solution can be made higher concentration. A concentration of the solid content of the silica dispersion according to the present invention is preferably in the range of 20 to 60% by weight, more preferably 30 to 50% by weight. As the commercially available bead mill, there may be mentioned a nano mill manufactured by Asada Iron Works Co., Ltd., a ultravisco mill manufactured by AIMEX Co., Ltd., an Annular type OB mill manufactured by MATSUBO CORPORATION, and a DYNO mill manufactured by Shinmaru Enterprises Corporation, etc.

As one of the embodiments of the present invention, when fumed silica fine particles having an average secondary particle diameter of 500 nm or less are used in addition to the above-mentioned precipitated silica fine particles having an average secondary particle diameter of 500 nm or less in the ink-receptive layer A, a ratio of the both materials to be used is in terms of a weight ratio of preferably in the range of from 30:70 to 70:30. The reason why the precipitated silica and the fumed silica are used in combination in the ink-receptive layer A is that as compared with the case where the precipitated silica is used alone, surface defect, particularly crack can be lowered when the ink-receptive layer A and the ink-receptive layer B are subjected to multi-layer coating and dried.

An average primary particle diameter of the fumed silica to be contained in the ink-receptive layer A of the present invention and in the ink-receptive layer B which is one of the embodiments of the present invention is preferably 50 nm or less, more preferably 5 to 30 nm. When the fumed silica is to be used in the ink-receptive layer, it is preferred that the fumed silica is pulverized to have an average secondary particle diameter of 500 nm or less in the presence of a cationic compound in an aqueous medium. As an example of the cationic compound, there may be mentioned the cationic polymer and the water-soluble metallic compound mentioned in the explanation of pulverization of the precipitated silica. At the time of pulverization, it is preferably carried out the procedure until the particles become finer with an average secondary particle diameter of 300 nm or less by using a high-pressure homogenizer or a media mill.

The precipitated silica and the fumed silica to be used in the ink-receptive layer A may be subjected to simultaneous dispersion and simultaneous pulverization, but it is advantageous in many cases to separately treat them to have optimum average secondary particle diameters, respectively.

The lower limit values of the average secondary particle diameter of the precipitated silica and the fumed silica are preferably 50 nm or so, in view of the facts that an energy cost rises in finer pulverization, or as an average secondary particle diameter is close to an average primary particle diameter, ink absorption property is observed to be lowered.

Alumina, and alumina hydrate to be contained in the ink-receptive layer B of the present invention is aluminum oxide or a hydrate thereof, which may be crystalline or non-crystalline, and those having irregular, sphere, or plate shaped, etc. are used. Either of which may be used and both of them may be used in combination.

As the alumina of the present invention, γ-alumina which is γ type crystal of aluminum oxide is preferred, of these, δ group crystal is preferred. In γ-alumina, it is possible to make a primary particle as small as 10 nm or so, and generally those in which secondary particle crystals having several thousands to several ten-thousands are pulverized to 50 to 300 nm or so by ultrasonic wave, a high pressure homogenizer, an opposed or mutual collision type jet pulverizer, etc., are preferably used.

Alumina hydrate of the present invention can be represented by the formula Al₂O₃.nH₂O. The alumina hydrate can be classified due to the difference in composition or crystal form into gibbsite, bayerite, norstrandite, boehmite, boehmite gel (pseudoboehmite), diaspore, amorphous non-crystalline, etc. Of these, in the above-mentioned formula, when the value of n is 1, it represents alumina hydrate with a boehmite structure, when n exceeds 1 and less than 3, it represents alumina hydrate with a pseudoboehmite structure, and when n is 3 or more, it represents alumina hydrate with a non-crystalline structure. In particular, the alumina hydrate preferably used in the present invention is alumina hydrate with a pseudoboehmite structure where n exceeds 1 and less than 3. The alumina hydrate can be obtained by the conventionally known preparation methods such as hydrolysis of aluminum alkoxide such as aluminum isopropoxide, etc., neutralization of an aluminum salt by an alkali, hydrolysis of aluminate, etc.

A shape of the alumina hydrate to be used in the present invention may be either of a platy, fibrous, needle, shpere, rod shape, etc., and a preferred shape in view of the ink absorption property is a platy with an aspect ratio of 2 or more. It is preferably an average aspect ratio of 3 to 6. The aspect ratio is represented by a ratio of “a diameter” relative to “a thickness” of the particle. Here, the diameter of the particle means a diameter of a circle with an equal projected surface area of the particle of alumina hydrate when it is observed by an electron microscope. When the aspect ratio is less than 2, fine pore size distribution of the ink-receptive layer becomes narrow, and the ink absorption property is lowered. On the other hand, when the aspect ratio exceeds 8, it becomes difficult to prepare alumina hydrate with a uniform grain size.

The average primary particle diameter of the fumed silica, precipitated silica, alumina and alumina hydrate of the present invention can be obtained from an observation by an electron microscope where the particles are dispersed, and for each of 100 particles existing in a predetermined area, a primary particle diameter of a circle whose area is equivalent to a projected area of each particle is taken as a primary particle diameter for that particle, and these values are averaged. The average secondary particle diameter of the fumed silica, precipitated silica, alumina and alumina hydrate of the present invention can be obtained by measuring a dilute dispersion with a laser diffraction/scatter type particle size distribution measurement device.

In the present invention, the hydrophilic binder to be used in combination with the inorganic fine particles in the ink-receptive layer is mainly a polyvinyl alcohol, and preferably a completely or partially saponified polyvinyl alcohol or a cation-modified polyvinyl alcohol.

Preferred completely or partially saponified polyvinyl alcohol is a partially or completely sapoinified one with a saponification degree of 80% or more, and an average polymerization degree of 200 to 5000. Also, as the cation-modified polyvinyl alcohol, there may be mentioned, for example, a polyvinyl alcohol having a primary to tertiary amino group or a quaternary ammonium group at the main chain or a side chain of the polyvinyl alcohol as disclosed in Japanese Unexamined Patent Publication No. sho.61-10483.

In the present invention, other hydrophilic binders than those as mentioned above may be used in combination, but the amount thereof is preferably 20 parts by weight or less based on 100 parts by weight of the polyvinyl alcohol.

In the present invention, other cross-linking agent (film hardener) may be used in combination with the above-mentioned hydrophilic binder. Specific examples of the cross-linking agent may include an aldehyde type compound such as formaldehyde and glutaraldehyde, a ketone compound such as diacetyl and chloropentanedione, a compound having a reactive halogen such as bis(2-chloroethylurea), 2-hydroxy-4,6-dichloro-1,3,5-triazine, and those as disclosed in U.S. Pat. No. 3,288,775, divinylsulfone, a compound having a reactive olefin as disclosed in U.S. Pat. No. 3,635,718, a N-methylol compound as disclosed in U.S. Pat. No. 2,732,316, an isocyanate compound as disclosed in U.S. Pat. No. 3,103,437, an aziridine compound as disclosed in U.S. Pat. No. 3,017,280 and U.S. Pat. No. 2,983,611, a carbodiimide type compound as disclosed in U.S. Pat. No. 3,100,704, an epoxy compound as disclosed in U.S. Pat. No. 3,091,537, a halogen carboxyaldehyde compound such as mucochloric acid, a dioxane derivative such as dihydroxy-dioxane, an inorganic cross-linking agent such as chromium alum, zirconium sulfate, boric acid, a borate and borax, and they may be used independently or in combination of two or more. Of these, boric acid or a borate are particularly preferred. Boric acid to be used in the present invention may include ortho-boric acid, meta-boric acid, hypoboric acid, etc., and the borate may include a sodium salt, a potassium salt or an ammonium salt of the above-mentioned materials.

By using a polyvinyl alcohol and boric acid or a borate as a film-hardening agent in the lower side ink-receptive layer A, good surface glossiness and high ink absorption property can be obtained, and blur after printing can be made little. It can be considered that by adding boric acid or a borate, fine cracks in the lower side ink-receptive layer can be prevented, which affects to the surface glossiness of the upper side ink-receptive layer B, to give a recording material having high surface glossiness.

In the ink-receptive layer A of the present invention, an amount of the polyvinyl alcohol to be used shall be made less than 20 parts by weight based on 100 parts by weight of the precipitated silica fine particles or the precipitated silica fine particles and the fumed silica fine particles, preferably 8 to 19 parts by weight. By making the above-mentioned range, high ink absorption property can be obtained. Also, in the ink-receptive layer A of the present invention, a content of the boric acid or the borate based on 100 parts by weight of the polyvinyl alcohol is preferably 0.02 to 50 parts by weight, more preferably 0.5 to 35 parts by weight.

In the ink-receptive layer B of the present invention, an amount of the polyvinyl alcohol to be used is required to be less than 25 parts by weight based on 100 parts by weight of the fumed silica, alumina or alumina hydrate, more preferably in the range of 8 to 24 parts by weight. By making the above-mentioned range, high surface glossiness, sufficient surface strength, and good ink absorption property can be obtained. When it is added in an amount of 25 parts by weight or more, ink absorption property is markedly lowered. In the ink-receptive layer B of the present invention, a content of the boric acid or the borate based on 100 parts by weight of the polyvinyl alcohol is preferably 0.005 to 50 parts by weight, more preferably 0.01 to 30 parts by weight.

A dried coating amount of the ink-receptive layer A is preferably in the range of 8 to 40 g/m², more preferably 10 to 30 g/m². This range is preferred in view of an ink absorption property, coloring property, and blur after printing. Also, a dried coating amount of the ink-receptive layer B is preferably in the range of 0.5 to 18 g/m², more preferably 1 to 10 g/m². The above-mentioned range is preferred in view of surface glossiness, coloring property, and blur after printing. Of these, a dried coating amount of the ink-receptive layer B when fumed silica is contained in the ink-receptive layer B is preferably in the range of 0.2 to 4 g/m², particularly preferably 0.5 to 4 g/m² in terms of an amount of the fumed silica. The above-mentioned range is preferred in view of ink absorption property, coloring property, and resistance to crack by folding.

A sum of the dried coating amounts of the ink-receptive layer A and the ink-receptive layer B is preferably 12 to 45 g/m², more preferably 15 to 30 g/m². The above-mentioned range is preferred in view of ink absorption property and strength of the ink-receptive layer.

The respective ink-receptive layers of the present invention preferably further contain a cationic compound for the purpose of improving water resitance, etc. Examples of the cationic compound may be mentioned the cationic polymer and the water-soluble metallic compound mentioned in the explanation of pulverization of the precipitated silica. In particular, a cationic polymer with a molecular weight of 5,000 to 100,000 or so, and a compound comprising aluminum a metal of Group 4A (for example, zirconium, titanium) of the Periodic Table are preferred. The cationic compound may be used alone or may be used in combination of a plural number of compounds in combination.

In the present invention, to the respective ink-receptive layers, in addition to a surfactant and a film-hardening agent, various kinds of conventionally known additives such as a coloring dye, a coloring pigment, a fixing agent of an ink dye, an UV absorber, an antioxidant, a dispersing agent of the pigment, a defoaming agent, a leveling agent, an antiseptic agent, a fluorescent brightner, a viscosity stabilizer, a pH controller, etc. may be further added.

In the present invention, as the ink-receptive layer, other layer(s) may be provided other than the ink-receptive layers A and B, and in this case, it is necessary to be a layer which does not impair ink permeation property. For example, for the purpose of improving flaw resistance, it is preferred to provide a protective layer mainly comprising colloidal silica on the ink-receptive layer with an extent that it does not lower ink absorption property, for example, with a coating amount of about 5 g/m² or less in a solid content. An average particle diameter of the primary particles of the colloidal silica in general is 5 to 100 nm or so, and it is preferred to form secondary particles with an average particle diameter of 10 to 500 nm or so in view of ink absorption property. As a commercially available spherical silica, there may be mentioned SNOWTEX 20, etc., available from Nissan Chemical Industries, Ltd., cataloid USB, etc., available from CATALYSTS & CHEMICALS IND. CO., LTD., as a chain state, there may be mentioned SNOWTEX UP, etc., available from Nissan Chemical Industries, Ltd., and as a pearl necklace shape, there may be used SNOWTEX PS-M, etc., available from Nissan Chemical Industries, Ltd. Also, colloidal silica in which the surface of the colloidal silica is modified to cationic can be preferably used, of these, it is preferred that the surface of which is cationically modified by an aluminum compound. As the alumina-modified colloidal silica, there may be mentioned SNOWTEX AK-L, SNOWTEX AK-UP, SNOWTEX PS-M-AK, etc., available from Nissan Chemical Industries, Ltd.

In the present invention, a coating method of the respective layers constituting the ink-receptive layer can be used those coating methods conventionally known in the art. There may be mentioned, for example, a slide bead system, a curtain system, an extrusion system, an air knife system, a roll coating system, a rod bar coating system, etc.

In the present invention, by coating respective layers which constitute the ink-receptive layer such as the ink-receptive layer A, B, etc., substantially simultaneously without providing a drying step with a slide bead system, etc., characteristics required for the respective layers can be obtained with good efficiency, and this is preferred in the point of production efficiency. That is, by laminating the respective layers in a wet condition, the components contained in the respective layers are difficultly permeated into the lower layer, so that it can be expected that the constitution of the components of the respective layers can be well maintained after drying.

When a coating solution of the ink-receptive layer is coated on a film support or a resin-coated paper, a corona discharge treatment, a flame treatment, an untraviolet ray irradiation treatment, a plasma treatment, etc., is/are carried out prior to the coating.

In the present invention, when a support is used, in particular, a film or a resin-coated paper which is a water-resistant support is used, it is preferred to provide a primer layer mainly comprising a natural polymer compound or a synthetic resin on a surface on which the ink-receptive layer is to be provided. On the primer layer, an ink-receptive layer containing inorganic fine particles of the present invention is coated, then, it is cooled, and dried at a relatively low temperature, transparency of the ink-receptive layer is further improved.

The primer layer provided on the support mainly comprises a natural polymer compound such as gelatin, casein, etc., or a synthetic resin. Such a synthetic resin may be mentioned an acrylic resin, a polyester resin, vinylidene chloride, a vinyl chloride resin, a vinyl acetate resin, polystyrene, a polyamide resin, a polyurethane resin, etc.

The above-mentioned primer layer is provided on the support with a thickness (dry film thickness) of 0.01 to 5 μm. It is preferably in the range of 0.05 to 5 μm.

To the support of the present invention, various kinds of back coating layers can be provided by coating for the purpose of writing property, anti-static property, conveying property, anti-curl property, etc. To the back coating layer, an inorganic antistatic agent, an organic antistatic agent, a hydrophilic binder, latex, pigment, a curing agent, a surfactant, etc., may be contained with an optional combination.

### EXAMPLE

In the following, the present invention will be explained in more detail by referring to Examples, but the contents of the present invention are not limited by Examples. Incidentally, all part(s) and % mean part(s) by weight and % by weight, respectively, otherwise specifically mentioned.

### Example 1

<Preparation of Paper Support Coated with Polyolefin Resin>

A mixture of a bleached kraft pulp of hardwood (LBKP) and a bleached sulfite pulp of softwood (NBSP) with a ratio of 1:1 was subjected to beating until it becomes 300 ml by the Canadian Standard Freeness to prepare a pulp slurry. To the slurry were added alkyl ketene dimer in an amount of 0.5% based on the amount of the pulp as a sizing agent, polyacrylamide in an amount of 1.0% based on the same as a strengthening additive of paper, cationic starch in an amount of 2.0% based on the same, and a polyamide epichlorohydrin resin in an amount of 0.5% based on the same, and the mixture was diluted with water to prepare a slurry with a concentration of 1%. This slurry was made paper by a tourdrinier paper machine to have a basis weight of 170 g/m², dried and subjected to moisture conditioning to prepare a base paper for a polyolefin resin-coated paper. A polyethylene resin composition comprising a low density polyethylene having a density of 0.918 g/cm³ and 10% of anatase type titanium oxide based on the low density polyethylene and dispersed uniformly in the resin was melted at 320° C. and the melted resin composition was subjected to extrusion coating on a surface of the above-mentioned base paper with a thickness of 35 μm by 200 m/min and subjected to extrusion coating by using a cooling roller subjected to slightly roughening treatment to make a resin-coated paper surface. On the other surface of the base paper, a blended resin composition comprising 70 parts by weight of a high density polyethylene resin having a density of 0.962 g/cm³ and 30 parts by weight of a low density polyethylene resin having a density of 0.918 g/cm³ was melted similarly at 320° C. and the melted resin composition was subjected to extrusion coating with a thickness of 30 μm and subjected to extrusion coating by using a cooling roller subjected to roughening treatment to make a resin-coated paper back surface.

Onto the front surface of the above-mentioned polyolefin resin-coated paper was subjected to a high frequency corona discharge treatment, and then, a coating solution for forming a subbing layer having the composition mentioned below was coated thereon to have a gelatin amount of 50 mg/m² and dried to prepare a support.

<Subbing layer composition>

| | |
|---|---|
| Lime-treated gelatin | 100 parts |
| 2-Ethylhexyl sulfosuccinate | 2 parts |
| Chromium alum | 10 parts |

<Precipitated Silica Dispersion 1>

To water were added 4 parts of a dimethyldiallyl ammonium chloride homopolymer (molecular weight: 9,000) and 100 parts of precipitated silica (average primary particle diameter: 15 nm, average secondary particle diameter: 23 μm, oil absorption amount: 185 ml/100 g) to prepare a provisional dispersion by using a saw blade type dispersing device (blade rim speed: 30 m/sec). Next, the obtained provisional dispersion was passed once through a bead mill under the conditions of zirconia beads with a diameter of 0.3 mm, a filling rate of 80% by volume and a disc rim speed of 10 m/sec to prepare Precipitated silica dispersion 1 with a solid concentration of 30% and an average secondary particle diameter of 200 nm.

<Precipitated Silica Dispersion 2>

To water were added 4 parts of a dimethyldiallyl ammonium chloride homopolymer (molecular weight: 9,000) and 100 parts of precipitated silica (average primary particle diameter: 11 nm, average secondary particle diameter: 3 μm, oil absorption amount: 220 ml/100 g), and the mixture was dispersed by using a saw blade type dispersing device (blade rim speed: 30 m/sec) to prepare a provisional dispersion. Next, the obtained provisional dispersion was passed once through a bead mill under the conditions of zirconia beads with a diameter of 0.3 mm, a filling rate of 80% by volume and a disc rim speed of 10 m/sec to prepare Precipitated silica dispersion 2 with a solid concentration of 15% and an average secondary particle diameter of 200 nm.

<Fumed Silica Dispersion>

To water were added 4 parts of a dimethyldiallyl ammonium chloride homopolymer (molecular weight: 9,000) and 100 parts of fumed silica (average primary particle diameter: 7 nm), and the mixture was dispersed by using a saw blade type dispersing device (blade rim speed: 30 m/sec) to prepare a provisional dispersion. Next, the obtained provisional dispersion was passed once through a pressure homogenizer under the conditions of 40 MPa to prepare fumed silica dispersion with a solid concentration of 20% and an average secondary particle diameter of 150 nm.

Recording Material 1 (Present Invention)

On the surface of the above-mentioned support were simultaneously coated a coating solution for an ink-receptive layer A1 and a coating solution for an ink-receptive layer B1 having the compositions mentioned below so that dried coating amounts of silica of the ink-receptive layer A1 being 23 g/m², and that of the ink-receptive layer B1 being 2 g/m², by using a slide bead coating device, and dried to prepare Recording material 1. Incidentally, the ink-receptive layer A1 is a lower layer nearer to the support, and the ink-receptive layer B1 is an upper layer. The drying conditions after the coating were that the coated material was cooled at 0° C. for 30 seconds, at 42° C. under 10% RH until the concentration of the total solid content became 90%, and then, at 35° C. under 10% RH.

<Composition for Ink-receptive layer A1>

| | | |
|---|---|---|
| Precipitated silica dispersion 1 (as a silica solid | 100 | parts |
| content) | | |
| Boric acid | 2.5 | parts |
| Polyvinyl alcohol | 15 | parts |
| (Saponification degree: 88%, average | | |
| polymerization degree: 3500) | | |
| Surfactant | 0.1 | part |
| Methylolmelamine series compound | 3 | parts |
| (BECKAMINE PM-N available from DAINIPPON INK | | |
| AND CHEMICALS, INCORPORATED) | | |

<Composition for Ink-receptive layer B1>

| | | |
|---|---|---|
| Fumed silica dispersion (as a silica solid content) | 100 | parts |
| Boric acid | 5 | parts |
| Polyvinyl alcohol | 20 | parts |
| (Saponification degree: 88%, average | | |
| polymerization degree: 3500) | | |
| Surfactant | 0.5 | part |

Recording Material 2 (Present Invention)

The coating solution for the ink-receptive layer A1 and the coating solution for the ink-receptive layer B1 were coated in the same manner as in Recording material 1 except for changing the dried coating amounts of silica of the ink-receptive layer A1 being 18 g/m², and that of the ink-receptive layer B1 being 7 g/m², to prepare Recording material 2.

Recording Material 3 (Present Invention)

In the same manner as in Recording material 1 except for using Precipitated silica dispersion 2 in place of Precipitated silica dispersion 1 in the composition for the ink-receptive layer A1, Recording material 3 was prepared.

Recording Material 4 (Comparative Example)

In the same manner as in Recording material 1 except for not coating the coating solution for the ink-receptive layer A1, and coating the coating solution for the ink-receptive layer B1 alone with the dried coating amount of silica of 25 g/m², Recording material 4 was prepared.

Recording Material 5 (Comparative Example)

In the same manner as in Recording material 1 except for not coating the coating solution for ink-receptive layer B1 , and coating the coating solution for the ink-receptive layer A1 alone with the dried coating amount of silica of 25 g/m², Recording material 5 was prepared.

Recording Material 6 (Comparative Example)

In the same manner as in Recording material 1 except for changing the added amount of the polyvinyl alcohol to 25 parts and the added amount of the boric acid to 4.2 parts in the composition of the ink-receptive layer A1, Recording material 6 was prepared.

Recording material 7 (Comparative example) In the same manner as in Recording material 1 except for changing the added amount of the polyvinyl alcohol to 27 parts and the added amount of the boric acid to 6 parts in the composition of the ink-receptive layer B1, Recording material 7 was prepared.

Recording Material 8 (Comparative Example)

<Precipitated Silica Dispersion 3>

In the same manner as in Precipitated silica dispersion 1 except for changing the diameter of zirconia beads from 0.3 mm to 3 mm in the provisional dispersion of the precipitated silica, Precipitated silica dispersion 3 having a concentration of the solid content of 30% and an average secondary particle diameter of 800 nm was prepared.

Next, the same procedure was carried out as in Recording material 1 except for using Precipitated silica dispersion 3 in place of Precipitated silica dispersion 1 in the composition of the ink-receptive layer A1, Recording material 8 was prepared.

With regard to the ink-jet recording materials prepared as mentioned above, the following evaluations were carried out. The results are shown in Table 1.

<Ink Absorption Property>

Cyan, magenta or yellow single color with 100% and a threefold color with 300% were each printed by using an ink-jet printer (manufactured by Seiko Epson Co., PM-880C), and a PPC paper was overlapped and slightly pressed to contact with the printed portion immediately after the printing, and a degree of an amount of ink transferred to the PPC paper was observed with naked eyes and evaluated totally by the following criteria.

⊚: Completely no transfer occurred.

◯: There is no transfer at 100% portion, but slightly transferred at 300% portion.

X: There is no transfer at 100% portion, but at 300% portion, ink is overflown and clearly transferred to a PPC paper.

X X: There is transfer at 100% portion.

<Coloring Property>

An image including scenery and a person was printed by using an ink-jet printer (manufactured by Seiko Epson Co., PM-880C), and feeling looked with eyes was judged by the following criteria.

◯: It has a feeling as that of a color photography.

Δ: It is slightly inferior to that of a color photography.

X: It is clearly inferior to that of a color photography.

X X: It is markedly inferior to that of a color photography.

Incidentally, in Recording material 6, ink was overflown so that this evaluation could not be carried out.

<Resistance to Crack by Folding>

Recording materials were each subjected to seasoning under the conditions of at 10° C. and 20% RH for 24 hours, and crack by folding was judged under the same temperature and same humidity conditions. The judgement method is a method that the recording material was cut to a length of 12 cm, and the ink-receptive layer was placed at an outer side, bending it in an arc shape and a diameter of the arc at which a crushed sound could be heard was measured. The smaller numerical value, that is, the smaller diameter means better resistance to crack by folding and shows that the material difficultly causes crack by folding. Since a product rolled to 2-inch core in a rolled state has been commercially available, it is necessary to show a numerical value of at least 50 mm or less for practical use.

TABLE 1

| | | | Resistance |
|---|---|---|---|
| | Ink | | to crack by |
| | absorption | Coloring | folding |
| | property | property | (mm) |
| Recording material 1 | ⊚ | ◯ | 38 |
| (Present invention) | | | |
| Recording material 2 | ⊚ | ◯ | 45 |
| (Present invention) | | | |
| Recording material 3 | ⊚ | Δ | 40 |
| (Present invention) | | | |
| Recording material 4 | ⊚ | ◯ | 67 |
| (Comparative example) | | | |
| Recording material 5 | ⊚ | X | 35 |
| (Comparative example) | | | |
| Recording material 6 | X | ◯ | 34 |
| (Comparative example) | | | |
| Recording material 7 | XX | — | 42 |
| (Comparative example) | | | |
| Recording material 8 | ◯ | XX | 32 |
| (Comparative example) | | | |

From the above-mentioned results, it can be understood that the ink-jet recording materials of the present invention have good ink absorption property and coloring property, and excellent in resistance to crack by folding.

Recording Material 9 (Present Invention)

A coating solution for an ink-receptive layer C1 having the composition shown below was prepared, and on the surface of the support and from the side nearer to the support, the coating solution for the ink-receptive layer A1, the coating solution for the ink-receptive layer B1 , and the coating solution for the ink-receptive layer C1 were simultaneously coated in this order by using a slide bead coating device, and dried to prepare Recording material 9. Temperature conditions at the time of drying are the same as in the preparation of Recording material 1. Dried coating amount of silica in the respective layers were so coated that the ink-receptive layer A1 was 23 g m², the ink-receptive layer B1 was 2 g/²m , and the ink-receptive layer C1 was 1 g/m².

<Composition for Ink receptive layer C1>

| | | |
|---|---|---|
| Colloidal silica (as a silica solid content) | 100 | parts |
| (available from Nissan Chemical Industries, Ltd., | | |
| SNOWTEX AK-L, average primary particle | | |
| diameter: 40 nm) | | |
| Polyvinyl alcohol | 5 | parts |
| (saponification degree: 88%, average | | |
| polymerization degree: 3500) | | |
| Surfactant | 0.3 | part |

The above-mentioned Recording material 9 had the same ink absorption property, coloring property and resistance to crack by folding as those of Recording material 1. Moreover, with regard to glossiness and flaw resistance, it was excellent than those of Recording material 1. With regard to the flaw resistance, the ink-jet recording material was cut with a size of 3 cm×4 cm, 1200 g of a weight was adhered to a surface opposite to the printing surface, and the sample adhered to the weight was placed on a PPC paper by making the printing surface down, the sample adhered to the weight was pulled with a rate of 50 cm/min for 20 cm, and disturbance of an image at the printed portion and a transferred degree to the PPC paper were judged with naked eyes and evaluated.

From the above-mentioned results, it can be understood that by providing a layer mainly containing colloidal silica at the layer farther from the support, the resulting material has good ink absorption property, coloring property and resistance to crack by folding, and further is high glossiness and excellent in flaw resistance.

### Example 2

Recording Material 10 (Present Invention)

On the surface of the above-mentioned support were simultaneously coated a coating solution for an ink-receptive layer A2 and a coating solution for an ink-receptive layer B2 having the compositions mentioned below so that dried coating amounts of silica of the ink-receptive layer A2 being 20 g/m², and that of the ink-receptive layer B2 being 4 g/m², by using a slide bead coating device, and dried to prepare Recording material 10. The ink-receptive layer A2 is a lower layer nearer to the support, and the ink-receptive layer B2 is an upper layer. The drying conditions after the coating were that the coated material was cooled at 5° C. for 30 seconds, at 45° C. under 10% RH until the concentration of the total solid content became 90%, and then, at 35° C. under 10% RH.

<Ink-receptive layer A2 composition>

| | | |
|---|---|---|
| Precipitated silica dispersion 1 (as a | 100 | parts |
| silica solid content) | | |
| Boric acid | 3 | parts |
| Polyvinyl alcohol | 15 | parts |
| (Saponification degree: 88%, average | | |
| polymerization degree: 3500) | | |
| Surfactant | 0.3 | part |

<Ink-receptive layer B2 composition>

| | | |
|---|---|---|
| Pseudoboehmite | 100 | parts |
| (Average primary particle diameter: 14 nm, average | | |
| secondary particle diameter 160 nm, | | |
| rectangular shaped particles) | | |
| Boric acid | 0.5 | part |
| Polyvinyl alcohol | 12 | parts |
| (Saponification degree 88%, average | | |
| polymerization degree 3500) | | |
| Surfactant | 0.3 | part |

Recording Material 11 (Present Invention)

In the same manner as in Recording material 10 except for changing the dried coated amount of the solid contents in Example 1 of the ink-receptive layer A2 being 12 g/m², and that of the ink-receptive layer B2 being 12 g/m², to prepare Recording material 11.

Recording Material 12 (Present Invention)

<Precipitated Silica Dispersion 4>

In the same manner as in Precipitated silica dispersion 1 except for changing the bead mill conditions to alkali-free glass beads with a diameter of 1 mm, a filling ratio of 70% and a disc rim speed of 10 m/sec, Precipitated silica dispersion 4 with a concentration of the solid content of 30% and an average secondary particle diameter of 320 nm was prepared.

Next, in the same manner as in Recording material 10 except for changing Precipitated silica dispersion 1 to Precipitated silica dispersion 4 in the above-mentioned ink-receptive layer A2 composition, Recording material 12 was prepared.

Recording Material 13 (Present Invention)

In the same manner as in Recording material 10 except for changing the pseudoboehmite to platy pseudoboehmite having an average primary particle diameter of 15 nm and an aspect ratio of 5 in the composition for the ink-receptive layer B2, Recording material 13 was prepared.

Recording Material 14 (Present Invention)

In the same manner as in Recording material 10 except for changing the pseudoboehmite to γ-alumina having an average primary particle diameter of 13 nm in the ink-receptive layer B2 composition, Recording material 14 was prepared.

Recording Material 15 (Present Invention)

In the same manner as in Recording material 10 except for using Precipitated silica dispersion 2 in place of Precipitated silica dispersion 1 in the composition for the ink-receptive layer A2, Recording material 15 was prepared.

Recording Material 16 (Present Invention)

In the same manner as in Recording material 1 except for changing the composition for the ink-receptive layer A2 to the composition mentioned below, Recording material 16 was prepared.

<Composition for Ink-receptive layer A3>

| | | |
|---|---|---|
| Precipitated silica dispersion 1 | 100 | parts |
| (as a silica solid content) | | |
| Boric acid | 3 | parts |
| Polyvinyl alcohol | 15 | parts |
| (Saponification degree 88%, average | | |
| polymerization degree 3500) | | |
| Basic poly(aluminum hydroxide) | 3 | parts |
| Surfactant | 0.3 | part |

Recording Material 17 (Present Invention)

A coating solution for an ink-receptive layer C2 having the composition shown below was prepared, and on the surface of the support and from the side nearer to the support, the coating solution for the ink-receptive layer A2, the coating solution for the ink-receptive layer B2, and the coating solution for the ink-receptive layer C2 were simultaneously coated in this order by using a slide bead coating device, and dried to prepare Recording material 17. Temperature conditions at the time of drying are the same as in the preparation of Recording material 10. Dried coating amount of silica in the respective layers were so coated that the ink-receptive layer A4 was 20 g/m², the ink-receptive layer B3 was 3 g/m², and the ink-receptive layer C2 was 1 g/m².

<Ink receptive layer C2 composition>

| | | |
|---|---|---|
| Colloidal silica (as a silica solid content) | 100 | parts |
| (Available from Nissan Chemical Industries, | | |
| Ltd., SNOWTEX AK-L, average primary | | |
| particle diameter: 40 nm) | | |
| Polyvinyl alcohol | 5 | parts |
| (Saponification degree 88%, average | | |
| polymerization degree 3500) | | |
| Boric acid | 2 | parts |
| Surfactant | 0.3 | part |

Recording Material 18 (Comparative Example)

In the same manner as in Recording material 10 except for not coating the coating solution for the ink-receptive layer B2, and coating the coating solution for the ink-receptive layer A2 alone with the dried coating amount of the solid content at drying of 24 g/m², Recording material 18 was prepared.

Recording Material 19 (Comparative Example)

In the same manner as in Recording material 10 except for not coating the coating solution for the ink-receptive layer A2, and coating the coating solution for the ink-receptive layer B2 alone with the dried coating amount of the solid content at drying of 24 g/m², Recording material 19 was prepared.

Recording Material 20 (Comparative Example)

In the same manner as in Recording material 10 except for changing silica dispersion 1 (silica solid content) to precipitated silica (average secondary particle diameter: 2 μm) which had been used without pulverization in the composition for the ink-receptive layer A2, Recording material 20 was prepared.

Recording Material 21 (Comparative Example)

In the same manner as in Recording material 10 except for using gel method silica (average secondary particle diameter: 300 nm) in place of silica dispersion 1 (silica solid content) in the composition for the ink-receptive layer A2, Recording material 21 was prepared.

Recording Material 22(Comparative Example)

In the same manner as in Recording material 10 except for changing the composition for the ink-receptive layer A2 to the composition mentioned below, Recording material 22 was prepared.

<Ink-receptive layer A4 composition>

| | | |
|---|---|---|
| Fumed silica (average primary particle diameter 20 nm) | 100 | parts |
| Dimethylallyl ammonium chloride homopolymer | 4 | parts |
| Boric acid | 4 | parts |
| Polyvinyl alcohol | 20 | parts |
| (Saponification degree 88%, average polymerization degree | | |
| 3500) | | |
| Surfactant | 0.1 | part |

With regard to the ink-jet recording materials prepared as mentioned above, the following evaluations were carried out. The results are shown in Table 2.

<Ink Absorption Property>

By using a commercially available ink-jet printer (manufactured by Canon Inc., BJF-870), solid printing with red, blue, green or black color was each carried out, and immediately after the printing, a PPC paper was overlapped over the printed portion with a slight pressurization, and the degree of an amount of the ink transferred to the PPC paper was observed with naked eyes. It was totally evaluated by the following criteria.

⊙: No transfer was observed.

◯: Slight transfer was observed but practically used.

Δ: Dark transfer was observed and practical use is difficult.

X: Ink was transferred on the whole surface and practical use is impossible.

<Coloring Property>

Solid printing with each color of cyan, magenta, yellow and black was carried out, and an optical density was measured by a Macbeth reflection densitometer, and the sum of the optical density of the respective colors was shown. The larger numerical value means good coloring property.

<Glossiness at White Paper Portion>

Glossiness at the white paper portion of the recording material before printing was observed with inclined light and evaluated by the following criteria.

⊙: It possesses high glossy feeling as that of a color photography.

◯: There is a glossy feeling, but slightly inferior to ©.

Δ: There is a glossy feeling as that of an art paper or a coated paper.

X: There is a low glossy feeling as that of uncoated paper.

<Blur at Preservation>

After printing an image, the sample preserved for a week in an alubum for photography was observed with naked eyes and judged by the following criteria.

⊙: No blur was observed.

◯: Slight blur was admitted.

Δ: Blur was admitted.

X: Remarkably blurred.

TABLE 2

| | | | Glossiness | |
|---|---|---|---|---|
| | | | at | |
| | Ink | | white | Blur at |
| | absorption | Coloring | paper | presser- |
| | property | property | portion | vation |
| Recording material 10 | ⊚ | 9.0 | ⊚ | ◯ |
| (Present invention) | | | | |
| Recording material 11 | ◯ | 8.7 | ⊚ | ◯ |
| (Present invention) | | | | |
| Recording material 12 | ⊚ | 8.1 | ◯ | ◯ |
| (Present invention) | | | | |
| Recording material 13 | ⊚ | 8.9 | ⊚ | ⊚ |
| (Present invention) | | | | |
| Recording material 14 | ⊚ | 8.5 | ◯ | ◯ |
| (Present invention) | | | | |
| Recording material 15 | ⊚ | 7.9 | ⊚ | ◯ |
| (Present invention) | | | | |
| Recording material 16 | ⊚ | 9.0 | ⊚ | ⊚ |
| (Present invention) | | | | |
| Recording material | ⊚ | 8.9 | ⊚ | ⊚ |
| 17 (Present invention) | | | | |
| Recording material 18 | ⊚ | 7.8 | ◯ | Δ |
| (Comparative example) | | | | |
| Recording material 19 | X | 8.9 | ⊚ | X |
| (Comparative example) | | | | |
| Recording material 20 | ⊚ | 6.9 | X | X |
| (Comparative example) | | | | |
| Recording material 21 | ◯ | 7.8 | ◯ | Δ |
| (Comparative example) | | | | |
| Recording material 22 | ⊚ | 8.0 | ⊚ | X |
| (Comparative example) | | | | |

From the above-mentioned results, it can be understood that the ink-jet recording materials of the present invention have good ink absorption property and white paper portion glossiness, excellent in coloring property, and less generating blur during preservation.

### Example 3

Recording material 23 (Present invention) On the surface of the above-mentioned support were simultaneously coated a coating solution for an ink-receptive layer A5 having the composition mentioned below and the coating solution for the ink-receptive layer B1 so that dried coating amounts of silica of the ink-receptive layer A5 being 20 g/m², and that of the ink-receptive layer B1 being 4 g/m², by using a slide bead coating device, and dried to prepare Recording material 23. The ink-receptive layer AS is a lower layer nearer to the support, and the ink-receptive layer B1 is an upper layer. The drying conditions after the coating were that the coated material was cooled at 5° C. for 30 seconds, at 45° C. under 10% RH until the concentration of the total solid content became 90%, and then, at 35° C. under 10% RH.

<Ink-receptive layer A5 composition>

| | | |
|---|---|---|
| Precipitated silica dispersion 1 (as silica solid | 50 | parts |
| component) | | |
| Fumed silica dispersion (as silica solid component) | 50 | parts |
| Boric acid | 3 | parts |
| Polyvinyl alcohol | 15 | parts |
| (Saponification degree: 88%, average | | |
| polymerization degree: 3500) | | |
| Surfactant | 0.3 | part |

Recording Material 24 (Present Invention)

In the same manner as in Recording material 23 except for changing the ratio of Precipitated silica dispersion 1 and the fumed silica dispersion in the composition of the ink-receptive layer AS to 30:70 as the solid content, Recording material 24 was prepared.

Recording Material 25 (Present Invention)

In the same manner as in Recording material 23 except for changing the ratio of Precipitated silica dispersion 1 and the fumed silica dispersion in the composition of the ink-receptive layer AS to 70:30 as the solid content, Recording material 25 was prepared.

Recording Material 26 (Present Invention)

In the same manner as in Recording material 23 except for changing the composition for the ink-receptive layer B1 to the composition for the ink-receptive layer B2, Recording material 26 was prepared.

Recording Material 27 (Present Invention)

In the same manner as in Recording material 26 except for changing the pseudoboehmite to γ-alumina having an average primary particle diameter of 13 nm in the composition for the ink-receptive layer B2, Recording material 27 was prepared.

Recording Material 28 (Present Invention)

In the same manner as in Recording material 23 except for changing the silica dispersion in the composition for the ink-receptive layer A5 to 100 parts of Precipitated silica dispersion 1 alone (as a silica solid content), Recording material 28 was prepared.

Recording Material 29 (Comparative Example)

<Precipitated Silica Dispersion 5>

To water were added 4 parts of a dimethyldiallyl ammonium chloride homopolymer (molecular weight: 9,000) and 100 parts of precipitated silica (average primary particle diameter: 18 nm, average secondary particle diameter: 2 μm, oil absorption amount: 200 ml/100 g), and the mixture was dispersed by using a saw blade type dispersing device (blade rim speed: 30 m/sec) to prepare Precipitated silica dispersion 5 having a concentration of the solid content of 30% and an average secondary particle diameter of 1.8 μm.

Next, in the same manner as in Recording material 23 except for changing the silica dispersion of the composition for the ink-receptive layer A5 to 100 parts of Precipitated silica dispersion 5 alone (as a silica solid content), Recording material 29 was prepared.

Recording Material 30 (Comparative Example)

In the same manner as in Recording material 23 except for changing the silica dispersion of the composition for the ink-receptive layer A5 to 100 parts of fumed silica dispersion alone (as a silica solid content), Recording material 30 was prepared.

Recording Material 31 (Comparative Example)

In the same manner as in Recording material 26 except for changing the silica dispersion of the composition for the ink-receptive layer A5 to 100 parts of fumed silica dispersion alone (as a silica solid content), Recording material 31 was prepared.

With regard to the ink-jet recording sheets prepared as mentioned above, the same evaluations as in Example 2 and the following evaluation were carried out. The results are shown in Table 3.

Surface Property>

⊙: Completely no problem.

◯: There is a slight defect but no crack was observed.

Δ: Crack can be observed.

X: There are many defects including cracks and it cannot be practically used.

TABLE 3

| | | | Glossi- | | |
|---|---|---|---|---|---|
| | Ink | | ness at | | |
| | absorp- | | white | Blur at | |
| | tion | Coloring | paper | presser | Surface |
| | property | property | portion | vation | property |
| Recording material | ⊚ | 8.6 | ◯ to ⊚ | ◯ | ⊚ |
| 23 (Present invention) | | | | | |
| Recording material | ⊚ | 8.7 | ◯ to ⊚ | ◯ | ⊚ |
| 24 (Present invention) | | | | | |
| Recording material | ⊚ | 8.4 | ◯ | ◯ | ◯ to ⊚ |
| 25 (Present invention) | | | | | |
| Recording material | ◯ | 9.0 | ⊚ | ⊚ | ⊚ |
| 26 (Present invention) | | | | | |
| Recording material | ◯ | 8.9 | ⊚ | ⊚ | ⊚ |
| 27 (Present invention) | | | | | |
| Recording material | ⊚ | 7.9 | ◯ | ◯ | Δ to ◯ |
| 28 (Present invention) | | | | | |
| Recording material | ⊚ | 7.5 | X | X to Δ | Δ to ◯ |
| 29 (Comparative | | | | | |
| example) | | | | | |
| Recording material | ⊚ | 8.5 | ◯ | (X) | X |
| 30 (Comparative | | | | | |
| example) | | | | | |
| Recording material | ◯ | 8.9 | ⊚ | (X) | X |
| 31 (Comparative | | | | | |
| example) | | | | | |

Note:
(X) means that there is whisker-like blur before initiation of the preservation for one week.

From the above-mentioned results, it can be understood that the recording material for inkjet of the present invention has good ink absorption property and glossiness at the white paper portion, and excellent in coloring property, less blur at preservation and little in surface defect.

### INDUSTRIAL APPLICABILITY

According to the present invention, ink-jet recording materials with high glossiness and excellent in ink absorption property, coloring property and resistance to crack by folding, less blur at the printed portion during preservation, and also excellent in glossiness and flaw resistance can be obtained, and surface defects such as crack by folding can be reduced.

1. An ink-jet recording material having a support and at least two ink-receptive layers each containing inorganic fine particles and a hydrophilic binder, which comprises an ink-receptive layer A nearer to the support containing precipitated silica fine particles having an average secondary particle diameter 500 nm or less, or precipitated silica fine particles having an average secondary particle diameter 500 nm or less and fumed silica fine particles having an average secondary particle diameter 500 nm or less, and containing less than 20 parts by weight of a polyvinyl alcohol based on 100 parts by weight of the whole silica fine particles in the ink-receptive layer A, and an ink-receptive layer B farther from the support containing at least one kind of fine particles selected from fumed silica, alumina and alumina hydrate and less than 25 parts by weight of a polyvinyl alcohol based on 100 parts by weight of the fine particles.

2. The ink-jet recording material according to claim 1, wherein the precipitated silica fine particles having an average secondary particle diameter of 500 nm or less are fine particles in which precipitated silica is pulverized to have an average secondary particle diameter of 500 nm or less in an aqueous medium.

3. The ink-jet recording material according to claim 2, wherein the fine particles in which the precipitated silica is pulverized are fine particles in which precipitated silica having an average secondary particle diameter of 5 μm or more is pulverized by using media mill in the presence of a cationic compound in an aqueous medium.

4. The ink-jet recording material according to claim 3, wherein an oil absorption amount of the precipitated silica is 210 ml/100 g or less.

5. The ink-jet recording material according to claim 1, wherein the fumed silica fine particles having an average secondary particle diameter of 500 nm or less are fine particles in which fumed silica is pulverized to have an average secondary particle diameter of 500 nm or less in the presence of a cationic compound in an aqueous medium.

6. The ink-jet recording material according to claim 1, wherein a weight ratio of the precipitated silica fine particles and fumed silica fine particles contained in the ink-receptive layer A is 30:70 to 70:30.

7. The ink-jet recording material according to claim 1, wherein the ink-receptive layer A contains boric acid or a borate.

8. The ink-jet recording material according to claim 1, wherein a dry coated amount of the ink-receptive layer B containing the fumed silica is 4 g/m² or less in an amount of the fumed silica

9. The ink-jet recording material according to claim 1, wherein the ink-receptive layer B contains boric acid or a borate.

10. The ink-jet recording material according to claim 1, wherein the alumina hydrate is a plate shaped alumina hydrate having an aspect ratio of 2 or more.

11. The ink-jet recording material according to claim 1, wherein the alumina hydrate is pseudoboehmite.

12. The ink-jet recording material according to claim 1, wherein the alumina is γ-alumina.

13. The ink-jet recording material according to claim 1, wherein a layer mainly comprising colloidal silica is further provided on the ink-receptive layer B.

14. The ink-jet recording material according to claim 1, wherein the support is a water-resistant support.
